(19) United States
(12) Patent Application Publication
(10) Pub. No.: US 2022/0040892 A1
(43) Pub. Date: Feb. 10, 2022

(54) CORE-SHELL MICRO-FOAMING AGENTS OF UNIFORM SIZE FOR FOAMED PLASTICS WITH ENHANCED MECHANICAL STRENGTH

(71) Applicant: Nano and Advanced Materials Institute Limited, Hong Kong (HK)

(72) Inventors: Xianqiao LIU, Hong Kong (HK); Yushen WANG, Hong Kong (HK); Yueying Chen, Hong Kong (HK)

(21) Appl. No.: 16/985,239

(22) Filed: Aug. 5, 2020

(51) Int. Cl. B29C 44/34

(52) U.S. Cl. CPC B29C 44/3461; B29K 2105/048; B29C 44/3442

(57) ABSTRACT

The present invention provides a method for preparing a uniform-sized core-shell foaming agent includes: providing a SPG membrane having a pore size ranging approximately from 0.5 to 50 μm; preparing a dispersed phase liquid including at least one shell material, at least one initiator, at least one cross-linker and at least one blowing agent; preparing a continuous phase liquid including at least one solvent, at least one salt, and at least one stabilizer; delivering a first pressurized gas to dispense the dispersed phase liquid to the continuous phase liquid through the SPG membrane; stirring until the uniform-sized emulsion being homogenous; initiating the polymerization of the uniform-sized emulsion to form microspheres; drying the microspheres to form the uniform-sized core shell foaming agent.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Technical Field

The present invention provides a uniform-sized core-shell foaming agent and a method of fabricating the same. In particularly, the uniform-sized core-shell foaming agent comprises an outer shell and an inner core.

### Background

Foamed plastic, or cellular plastics, usually have a unique structure including a solid polymer matrix and voids with gas phase. The foamed plastic is usually prepared by one of these methods: (1) extrusion foaming; in extrusion foaming process, the polymer resin is fed into the extruder and melted under high pressure; meanwhile, the blowing agents is also injected into the extruder to mix the gas in the polymer melt and cool within a relatively short distance in an extruder (2) foam injection molding; the foam injection molding is a low pressure molding process where an inert gas such as nitrogen is injected into the polymer melt to reduce the viscosity of the polymer melt due to the formation of polymer/nitrogen mixture and the plasticization effect (3) bead foaming; expandable beads are polymerized in the form of fine beads which comprises the blowing agents. Before the molding process, the plastic beads with the blowing agents are performed pre-expansion under a pre-expansion system so as to equilibrate the pressure between internal cells and atmosphere.

Usually, additives such as foaming agents would be added into the mixture to support and enhance the foaming process. However, these commercial foaming agents usually have broad size distribution such that this non-uniformity in sizes of foaming agents would give rise to various pore sizes in the final foamed products. These various pores formed in the final product would lead to undesirable drop in mechanical strength. Therefore, there is a need to provide a uniform-sized foaming agent which would have less impact on the mechanical strength of the final foamed product in a cost-effective method.

### SUMMARY OF THE INVENTION

In view of the foregoing problem, this disclosure provides a uniform-sized core-shell foaming agent and a method of fabricating the same.

Accordingly, one aspect of the present invention provides a method for preparing a uniform-sized core-shell foaming agent, which includes (1) providing a Shirasu Porous Glass (SPG) membrane having a pore size ranging approximately from 0.5 to 50 μm; (2) preparing a dispersed phase liquid comprising at least one shell material, at least one initiator, at least one cross-linker and at least one blowing agent; (3) preparing a continuous phase liquid comprising at least one solvent, at least one salt, and at least one stabilizer; (4) delivering a first pressurized gas to dispense the dispersed phase liquid to the continuous phase liquid through the SPG membrane so as to form a uniform-sized emulsion; (5) stirring until the uniform-sized emulsion being homogenous; (6) initiating the polymerization of the uniform-sized emulsion to form microspheres, and (7) drying the microspheres to form the uniform-sized core shell foaming agent.

In one embodiment of the present invention, the shell material is selected from poly lactic acid (PLA), poly(lactic-co-glycolic acid)(PLGA), polystyrene (PS), poly methacrylate (PMA), poly methyl Methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof.

In another embodiment of the present invention the shell material is in a concentration approximately from 4% to 90% by weight of the dispersed phase liquid.

In at least one embodiment, the initiator is selected from 2,2′-azobisisobutyronitrile, 2,2′-azobis(2-methylbutyronitrile), 2,2′-azobis(2,4-dimethylvaleronitrile) or any combination thereof.

In at least one embodiment, the cross-linker is selected from divinylbenzene, 1,4 butanediol dimethacrylate, ethyleneglycol dimethacrylate, triethylene glycol, dimethacrylate, Trimethylolpropane, trimethacrylate, or any combination thereof.

In at least one embodiment, the blowing agent is selected from C₄ to C₉ alkanes or any combination thereof.

In at least one embodiment, the blowing agent is in a concentration approximately from 5% to 50% by weight of the dispersed phase liquid.

In at least one embodiment, the stabilizer is selected from calcium carbonate, calcium sulfate, magnesium carbonate, calcium hydroxide, magnesium oxide, aluminum hydroxide, nickel hydroxide, poly vinyl alcohol, tween-80 or any combination thereof.

In at least one embodiment, the stabilizer is in a concentration approximately from 0.1% to 10% by weight of the continuous phase liquid.

In another embodiment, the stirring speed of the uniform-sized emulsion is at approximately 200 rpm to 1000 rpm.

In another embodiment, the temperature for the initiating the polymerization of the uniform-sized emulsion is at approximately 50° C. to 90° C.

In another embodiment, the temperature for the drying the microspheres is at approximately 40° C. to 100° C.

A foaming agent prepared by the present invention having a coefficient of variation (CV, the ratio of the standard deviation to the mean) value below 20%.

A foaming agent prepared by the present invention having the size approximately from 5 μm to 100 μm.

Another aspect of the present invention provides a temperature expandable microsphere which includes at least one outer shell being selected from poly lactic acid (PLA), poly(lactic-co-glycolic acid)(PLGA), polystyrene (PS), poly methacrylate (PMA), poly methyl, Methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof; at least one inner core being selected from one of C₄ to C₉ alkanes or any combination thereof. The size distribution of the microsphere is approximately from 5 to 100 μm. The thickness of the outer shell is approximately from 0.5 μm to 2 μm, and the CV value of the microsphere is below 20%,

A foamed plastic prepared by the microsphere in the present invention having tensile strength reduction below 50% and the density reduction below 20%.

### BRIEF DESCRIPTION OF THE DRAWINGS

The disclosure will become more fully understood from the detailed description given herein below for illustration only, and thus not limitative of the disclosure, wherein:

FIG. 1 illustrates a uniform-sized core-shell foaming agents including an out shell and an inner core.

FIG. 2A and FIG. 2B show the scanning electron microscope (SEM) images and the size distribution of the uniform-sized core-shell foaming agents according to one embodiment of the present invention.

FIG. 3 shows the color change of the PE product with or without the addition of the foaming agent according to another embodiment of the present invention.

FIG. 4 illustrates the process of the fabricating a uniform-sized core-shell foaming agent.

FIG. 5 shows the scanning electron microscope (SEM) image and the size distribution of the larger uniform-sized core-shell foaming agents according to another embodiment of the present invention.

### DEFINITIONS

The terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### DETAILED DESCRIPTION

The present invention will be described in detail through the following embodiments with appending drawings. It should be understood that the specific embodiments are provided for an illustrative purpose only, and should not be interpreted in a limiting manner.

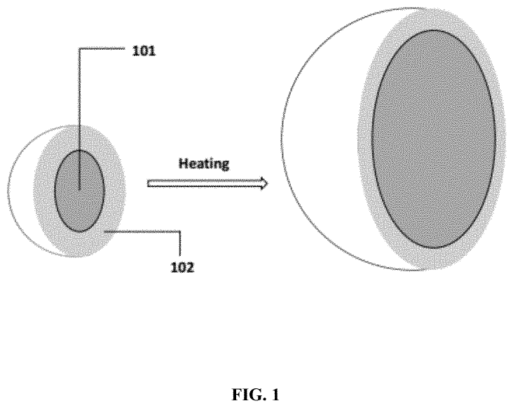

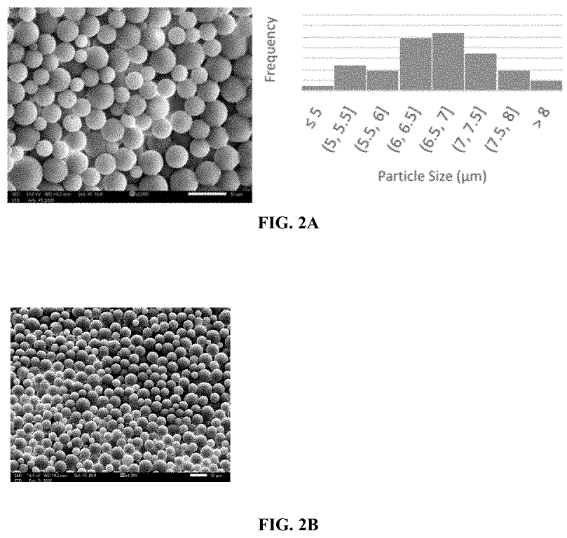

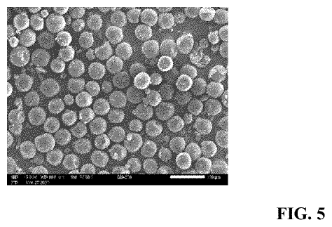

The present invention provides a temperature sensitive expandable microsphere with a core-shell structure and a preparation method thereof. The microsphere comprises at least one outer shell 101, and at least one inner core 102 as shown in FIG. 1. According to some embodiments of the present invention, the average size of the microspheres ranges from 5 to 100 μm and the CV value of the microsphere is below 20% (FIG. 2A, FIG. 2B and FIG. 5). For example, the CV value of the microsphere is 13.3%, 14.4%, 14.8%, 16.1%, 18.0%. In addition, the thickness of the outer shell is approximately from 0.2 μm to 2 μm.

According to some embodiments, the outer shell is made of polymers being selected from, for example, not limited to poly lactic acid (PLA), poly(lactic-co-glycolic acid)(PLGA), polystyrene (PS), poly methacrylate (PMA), poly methyl methacrylate (PMMA), polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof.

In some embodiments, the inner core is made of alkanes. Preferably the alkanes are selected from C₄ to C₉ alkanes, for example, not limited to pentane, butane, n-hexane, n-heptane, isooctane or any combination thereof.

In another embodiment, the microsphere is prepared by dispensing a dispersed phase solution to the continuous phase solution through a SPG membrane with a pore size ranging approximately from 0.5 to 50 μm so as to form a uniform-sized emulsion, then stirring the uniform-sized emulsion at the speed approximately 200 rpm to 1000 rpm, and followed by initiating the polymerization and drying of the microspheres. According to some embodiments, the dispersed phase solution includes at least one outer shell material, at least one initiator, at least one cross-linker and at least one blowing agent. The concentration of the shell material is approximately from 4% to 90% by weight of the dispersed phase solution, and the concentration of the blowing agent is approximately from 5% to 50% by weight of the dispersed phase solution. Meanwhile, the continuous phase solution includes at least one solvent, at least one salt and at least one stabilizer. The concentration of the stabilizer is approximately from 0.1% to 10% by weight of the continuous phase liquid.

In some embodiment, the outer shell material comprises one or more polymers, selected from, for example, but not limited to poly lactic acid (PLA), poly(lactic-co-glycolic acid)(PLGA), polystyrene (PS), poly methacrylate (PMA), poly methyl methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof.

In some embodiment, the initiator is selected from, for example, but not limited to 2,2′-azobisisobutyronitrile, 2,2′-azobis(2-methylbutyronitrile), 2,2′-azobis(2,4-dimethylvaleronitrile) or any combination thereof, and the cross-linker is selected from, for example, but not limited to divinylbenzene, 1,4 Butanediol Dimethacrylate, Ethyleneglycol dimethacrylate, Triethylene glycol dimethacrylate, Trimethylolpropane Trimethacrylate, or any combination thereof.

In some embodiment, the stabilizer is selected from, for example, but not limited to calcium carbonate, calcium sulfate, magnesium carbonate, calcium hydroxide, magnesium oxide, aluminum hydroxide, nickel hydroxide, poly vinyl alcohol, tween-80 or any combination thereof.

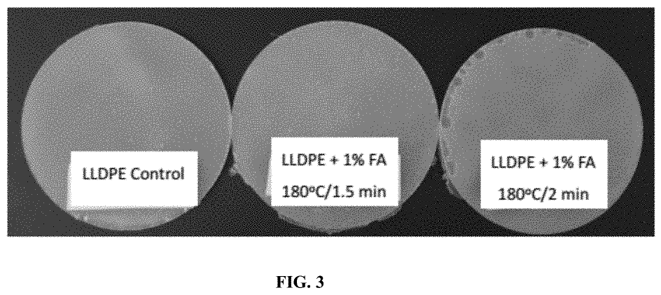

According to some embodiments, the temperature sensitive expandable microsphere with uniform-sized serves as a foaming agent to enhance the foaming process and alleviate the reduction of the tensile strength and the density of the foamed plastic comparing to the addition of the commercial foaming agent (Table 1). Preferably, the reduction of the tensile strength is below 50% and the reduction of the density is below 20%. In addition to alleviate the reduction of the mechanical strength of the foamed plastic, the microsphere is able to make no obvious yellow color change of the PE product with 1% foaming agent in the present invention comparing to the control PE product without foaming agent under the heating at 180° C. for 1.5 minutes and 2 minutes (FIG. 3). The product appears uniform with the help of small particle size, which contributes to uniform dispersion in the base PE material. Therefore, it is considered the foaming agent can withstand 180° C. processing temperature.

TABLE 1
comparison table of the foamed plastic with the
addition of the foaming agents in the present
invention and the commercial foaming agent

| | | | | | Tensile |
|---|---|---|---|---|---|
| | | | Density | | strength |
| | | | reduction | Tensile | reduction |
| | | Density | percentage | strength | percentage |
| | Composition | (g/cm³) | (%) | (MPa) | (%) |
| PP | Control | 0.903 | — | 25.2 | — |
| | +3% (the present | 0.780 | 14% | 12.7 | 49% |
| | invention) | | | | |
| | +3% (Brand A) | 0.499 | 45% | 6.17 | 75% |
| PLA | Control | 1.163 | — | 29.7 | — |
| | +3% (the present | 1.041 | 11% | 23.6 | 20% |
| | invention) | | | | |
| | +3% (Brand A) | 0.607 | 48% | 7.2 | 76% |

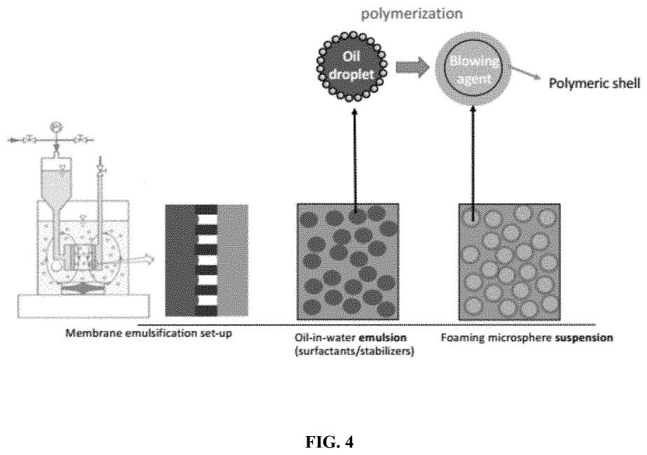

In another aspect of the present invention, it provides a method for preparing a uniform-sized core-shell foaming agent, which includes (1) providing a SPG membrane having a pore size ranging approximately from 0.5 to 50 μm; (2) preparing a dispersed phase liquid comprising at least one shell material, at least one initiator, at least one cross-linker and at least one blowing agent; (3) preparing a continuous phase liquid comprising at least one solvent, at least one salt, and at least one stabilizer; (4) delivering a first pressurized gas to dispense the dispersed phase liquid to the continuous phase liquid through the SPG membrane so as to form a uniform-sized emulsion; (5) stirring until the uniform-sized emulsion being homogenous; (6) initiating the polymerization of the uniform-sized emulsion to form microspheres; (7) drying the microspheres to form the uniform-sized core shell foaming agent. Referring to FIG. 4, it illustrates the process of preparing a uniform-sized core-shell foaming agent through a SPG membrane.

In some embodiments, the dispersed phase liquid comprises at least one shell material, at least one initiator, at least one cross-linker and at least one blowing agent. Further, the continuous phase liquid comprises at least one solvent, at least one salt, and at least one stabilizer. Table 2 shows the major components of the dispersed phase liquid described herein along with their corresponding weight percentage and exemplary materials for each of the components. Table 3 shows the major components of the continuous phase liquid described herein along with their corresponding weight percentage and exemplary materials for each of the components. A pressurized gas with approximately 0.01 to 0.5 MPa is delivered to dispense the dispersed phase liquid to the continuous phase liquid through the SPG membrane with a pore size ranging approximately from 0.5 to 50 μm so as to form a uniform-sized emulsion. The uniform-sized emulsion is stirring at the speed approximately from 200 rpm to 1000 rpm to obtain a homogenous emulsion and then apply the homogenous emulsion at approximately 50° C. to 90° C. to initiate the polymerization to form a core-shell structure comprising an outer shell and an inner core, and drying at approximately 40° C. to 100° C. to obtain the uniform-sized core shell foaming agent.

TABLE 2
Major components and corresponding weight percentage of the dispersed phase liquid

| Component | Percentage | Exemplary Materials |
|---|---|---|
| Shell material | 4% to 90% | poly lactic acid (PLA), poly(lactic-co-glycolic acid)(PLGA), |
| | | polystyrene (PS), poly methacrylate (PMA), poly methyl |
| | | Methacrylate (PMMA), or polymers comprising one or more |
| | | monomers of acrylonitrile, methacrylonitrile, 3-butene nitrile, |
| | | methacrylate, ethyl acrylate, propyl acrylate, butyl acrylate, methyl |
| | | methacrylate, methyl ethyl acrylate, and/or glycidyl methacrylate |
| Initiator | 0.01% to 5% | 2,2′-azobisisobutyronitrile, 2,2′-azobis(2-methylbutyronitrile), 2,2′- |
| | | azobis(2,4-dimethylvaleronitrile) |
| Cross-linker | 0.001% to −0.03% | divinylbenzene, 1,4 Butanediol Dimethacrylate, Ethyleneglycol |
| | | dimethacrylate, Triethylene glycol dimethacrylate, |
| | | Trimethylolpropane Trimethacrylate |
| Blowing agent | 5% to 50% | C₄ to C₉ alkanes |
| Solvent | 0% to 96% | dichloromethane, chloroform |

TABLE 3
Major components and corresponding weight
percentage of the continuous phase liquid

| Component | Percentage | Exemplary Materials |
|---|---|---|
| stabilizer | 0.1% to 10% | calcium carbonate, calcium sulfate, magnesium carbonate, |
| | | calcium hydroxide, magnesium oxide, aluminum hydroxide, |
| | | nickel hydroxide, poly vinyl alcohol, tween-80 |

### EXAMPLES

The foaming agent is prepared as follows. The disperse phase (oil phase) solution is made by dissolving PLA in dichloromethane solvent and blowing agents such as iso-pentane, hexane, heptane and isooctane. Hexane is selected as the candidate as it has higher boiling point than dichloromethane and it is easier to blow when heated as blowing agent in expandable microspheres. The continuous phase (water phase) is poly vinyl alcohol (PVA) solution. The two phases are mixed together and poured in the machine with SPG membrane. Then the mixture with uniform size distribution droplets will be prepared. Later, the mixture will be placed with stirring at 300 rpm for 4 hours to evaporate volatile dichloromethane. The PLA polymer shell will be extracted and form microsphere shell, where hexane is kept inside the microsphere because it has higher boiling point and is less likely to evaporate rather than dichloromethane solvents. Later the mixture will be centrifuged at 7200 rcf such that the microspheres will be separated from the water phase. Next the microspheres are washed in deionized water and centrifuged at 900 rcf again to remove PVA stabilizer. After drying, the final product was obtained. Referring to table 4, it shows the CV values and average sizes of foaming agents prepared with different concentrations of hexane to PLA and PVA by passing through the SPG membrane with the pore size of 20 μm under the extrusion pressure 0.03 MPa. The average size of the foaming agent is approximately from 5 to 8 μm (FIG. 2A and FIG. 2B)

TABLE 4
CV values and average size in different
concentrations of hexane to PLA and PVA

| Sample | Hexane to PLA | PVA conc. | CV value | Average size |
|---|---|---|---|---|
| 1 | 5% | 1% | 14.8% | 6.7 μm |
| 2 | 25% | 2% | 16.1% | 6.0 μm |

The following step is made for foaming agents with larger sizes, which contains polymerization. The contents for oil and water phases and the experimental parameters are as follows:

Oil phase: Acrylonitrile (10.6 g): Methyl methacrylate (4 g): alkanes (3.6 g): AIBN (0.2 g): BDDMA (0.02 g).

### Water Phase: MgCl₂ (2.7 g) NaCl (12 g) Water (46 g)

SPG settings: 10 μm, 0.43 MPa

### NaOH Solution: 30%, 5 g

The oil phase and water phase are mixed and emulsified through SPG to obtain a mixture. Next, it is stirred at 1000 rpm, with introducing NaOH solution. Here, Mg(OH)₂ precipitate on the oil droplet surface and behave as stabilizer. After 5 min, the system is transferred into a reactor. Polymerization is at 62° C. for 16 h. After polymerization, excess HCl is added to dissolve Mg(OH)₂ stabilizer. After filtration and washing with deionized water, the microspheres are dried at 50° C. for 12 h to obtain final product. Referring to table 5, it shows the CV values and average sizes of foaming agents prepared with different blowing agents by passing through the SPG membrane with the pore size of 10 μm under the extrusion pressure 0.43 MPa. The average size of the foaming agent is over 25 μm (FIG. 5).

TABLE 5
CV values and average size in different
AN-MMA copolymer based foaming agents

| | Blowing | Stir at | CV | Average |
|---|---|---|---|---|
| Sample | agent | polymerization | value | size |
| 1 | 24% Hexane | 1000 rpm | 18.0% | 28.8 μm |
| 2 | 24% Isooctane | 900 rpm | 13.3% | 47.8 μm |
| 3 | 24% Hexane | 800 rpm | 14.4% | 63.8 μm |

1. A method for preparing a uniform-sized core-shell foaming agent, comprising:
providing a Shirasu Porous Glass (SPG) membrane having a pore size ranging approximately from 0.5 to 50 μm;
preparing a dispersed phase liquid comprising at least one shell material, at least one initiator, at least one cross-linker and at least one blowing agent;
preparing a continuous phase liquid comprising at least one solvent, at least one salt, and at least one stabilizer;
delivering a first pressurized gas to dispense the dispersed phase liquid to the continuous phase liquid through the SPG membrane so as to form a uniform-sized emulsion;
stirring until the uniform-sized emulsion being homogenous;
initiating the polymerization of the uniform-sized emulsion to form microspheres;
drying the microspheres to form the uniform-sized core shell foaming agent.

2. The method of claim 1, wherein the shell material is selected from poly lactic acid (PLA), poly(lactic-co-glycolic acid)(PLGA), polystyrene (PS), poly methacrylate (PMA), poly methyl Methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof.

3. The method of claim 1, wherein the at least one shell material is in a concentration approximately from 4% to 90% by weight of the dispersed phase liquid.

4. The method of claim 1, wherein the at least one initiator is selected from 2,2′-azobisisobutyronitrile, 2,2′-azobis(2-methylbutyronitrile), 2,2′-azobis(2,4-dimethylvaleronitrile) or any combination thereof.

5. The method of claim 1, wherein the at least one cross-linker is selected from divinylbenzene, 1,4 Butanediol Dimethacrylate, Ethyleneglycol dimethacrylate, Triethylene glycol dimethacrylate, Trimethylolpropane, Trimethacrylate, or any combination thereof.

6. The method of claim 1, wherein the at least one blowing agent is selected from C₄ to C₉ alkanes or any combination thereof.

7. The method of claim 1, wherein the at least one blowing agent is in a concentration approximately from 5% to 50% by weight of the dispersed phase liquid.

8. The method of claim 1, wherein the at least one stabilizer is selected from calcium carbonate, calcium sulfate, magnesium carbonate, calcium hydroxide, magnesium oxide, aluminum hydroxide, nickel hydroxide, poly vinyl alcohol, tween-80 or any combination thereof.

9. The method of claim 1, wherein the at least one stabilizer is in a concentration approximately from 0.1% to 10% by weight of the continuous phase liquid.

10. The method of claim 1, wherein said stirring the uniform-sized emulsion is at approximately 200 rpm to 1000 rpm.

11. The method of claim 1, wherein said initiating the polymerization of the uniform-sized emulsion is at approximately 50° C. to 90° C.

12. The method of claim 1, wherein said drying the microspheres is at approximately 40° C. to 100° C.

13. A foaming agent prepared according to the method of claim 1 having a coefficient of variation (CV) value below 20%.

14. The foaming agent according to claim 13, wherein the size of the foaming agent is approximately from 5 μm to 100 μm.

15. A temperature sensitive expandable microsphere, comprising:
at least one outer shell being selected from poly lactic acid (PLA), poly(lactic-co-glycolic acid)(PLGA), polystyrene (PS), poly methacrylate (PMA), poly methyl Methacrylate (PMMA), or polymers comprising one or more monomers of acrylonitrile, methacrylonitrile, 3-butene nitrile, methacrylate, ethyl acrylate, propyl acrylate, butyl acrylate, methyl methacrylate, methyl ethyl acrylate, glycidyl methacrylate, or any combination thereof;
at least one inner core being selected from pentane, butane, n-hexane, n-heptane, isooctane or any combination thereof;
wherein the size distribution of the microsphere is approximately from 5 to 100 μm;
wherein the thickness of the outer shell is approximately from 0.5 μm to 2 μm.
wherein the CV value of the microsphere is below 20%;

16. A foamed plastic comprising the microsphere of claim 15, wherein the tensile strength reduction is below 50%; wherein the density reduction is below 20%.
